(19) United States
(12) Patent Application Publication
(10) Pub. No.: US 2025/0376848 A1
(43) Pub. Date: Dec. 11, 2025

(54) SILICONE ROOFING MEMBRANES AND RELATED METHODS

(71) Applicant: BMIC LLC, Dallas, TX (US)

(72) Inventors: Yan Zheng, Parisippany, NJ (US); Andrew Erick Andrade, Hackensack, NJ (US)

(21) Appl. No.: 19/230,683

(22) Filed: Jun. 6, 2025

Related U.S. Application Data
(60) Provisional application No. 63/657,250, filed on Jun. 7, 2024.

(51) Int. Cl. E04D 13/16; B32B 5/20; B32B 7/06; B32B 7/12; B32B 25/04; B32B 25/20; E04D 5/06; E04D 5/08; E04D 5/10; E04D 5/14

(52) U.S. Cl. CPC E04D 13/1643; B32B 5/20; B32B 7/06; B32B 7/12; B32B 25/042; B32B 25/045; B32B 25/20; E04D 5/06; E04D 5/08; E04D 5/10; E04D 5/148; B32B 2266/0207; B32B 2266/06; B32B 2307/72; B32B 2307/7376; B32B 2419/06

(57) ABSTRACT

Silicone roofing membranes and related systems and related methods are provided. A roofing membrane may comprise a multi-layered silicone composite and an adhesive layer located on the multi-layered silicone composite. The multi-layered silicone composite may comprise a cured silicone top layer, and at least one cured silicone core layer located between the cured silicone top layer and the adhesive layer.

### CROSS-REFERENCE TO RELATED APPLICATIONS

This application claims priority to and benefit of U.S. Provisional Patent Application No. 63/657,250 filed Jun. 7, 2024 and entitled “SILICONE ROOFING MEMBRANES AND RELATED METHODS,” the entirety of which is herein incorporated by reference.

### FIELD

This disclosure generally relates to silicone roofing membranes and related methods.

### BACKGROUND

During manufacturing, roofing membranes are formed with various defects. These defects frequently result in the roofing membranes being discarded as waste.

### SUMMARY

Some embodiments relate to a roofing membrane. In some embodiments, the roofing membrane comprises a multi-layered silicone composite. In some embodiments, the multi-layered silicone composite comprises a cured silicone top layer. In some embodiments, the cured silicone top layer does not have a foam structure. In some embodiments, the multi-layer silicone composite comprises at least one cured silicone core layer. In some embodiments, the at least one cured silicone core layer is located on the cured silicone top layer. In some embodiments, the at least one cured silicone core layer has a foam structure. In some embodiments, the cured silicone top layer has a thickness that is at least 50% less than a total thickness of the multi-layered silicone composite. In some embodiments, the roofing membrane comprises an adhesive layer. In some embodiments, the at least one cured silicone core layer is located between the adhesive layer and the cured silicone top layer.

In some embodiments, the cured silicone top layer does not comprise a blowing agent. In some embodiments, the at least one cured silicone core layer comprises a blowing agent.

In some embodiments, the foam structure of the at least one cured silicone core layer comprises a closed cell foam.

In some embodiments, the foam structure of the at least one cured silicone core layer comprises an open cell foam.

In some embodiments, a density of the at least one cured silicone core layer is less than a density of the cured silicone top layer.

In some embodiments, a density of the at least one cured silicone core layer is 0.4 g/cm³ to 2 g/cm³.

In some embodiments, the multi-layered silicone composite has a thickness of 2 mils to 500 mils.

In some embodiments, the adhesive layer has a thickness of 1 mil to 200 mils.

In some embodiments, the at least one cured silicone core layer comprises a sufficient amount of cured silicone core layers such that the multi-layered silicone composite has a thickness of 2 mils to 500 mils.

In some embodiments, the roofing membrane comprises a release liner. In some embodiments, the release liner covers the adhesive layer.

In some embodiments, the roofing membrane comprises a first release liner. In some embodiments, the first release liner covers the cured silicone top layer. In some embodiments, the roofing membrane comprises a second release liner. In some embodiments, the second release liner covers the adhesive liner.

Some embodiments relate to a roofing system. In some embodiments, the roofing system comprises a roofing substrate. In some embodiments, the roofing system comprises a roofing membrane. In some embodiments, the roofing membrane is located on the roofing substrate. In some embodiments, the roofing membrane comprises a multi-layered silicone composite. In some embodiments, the multi-layered silicone composite comprises a cured silicone top layer. In some embodiments, the cured silicone top layer does not have a foam structure. In some embodiments, the multi-layer silicone composite comprises at least one cured silicone core layer. In some embodiments, the at least one cured silicone core layer is located on the cured silicone top layer. In some embodiments, the at least one cured silicone core layer has a foam structure. In some embodiments, the cured silicone top layer has a thickness that is at least 50% less than a total thickness of the multi-layered silicone composite. In some embodiments, the roofing membrane comprises an adhesive layer. In some embodiments, the adhesive layer is located between the at least one cured silicone core layer and the roofing substrate. In some embodiments, the adhesive layer adheres the roofing membrane to the roofing substrate.

In some embodiments, the roofing substrate comprises at least one of a plywood substrate, a glass substrate, a cellulosic substrate, a roof shingle, a mat, a fabric, a glass mat, a fiberglass mat, an underlayment, a roofing membrane, a roof deck, a photovoltaic (PV) panel, a modified bitumen (MODBIT) material, a roll good, a polyisocyanurate (ISO) foam board, a cover board, a pipe, a base sheet, a chimney, a wax paper, or any combination thereof.

In some embodiments, the roofing membrane contacts the roofing substrate.

In some embodiments, a density of the at least one cured silicone core layer is less than a density of the cured silicone top layer.

In some embodiments, a density of the at least one cured silicone core layer is 0.4 g/cm³ to 2 g/cm³.

In some embodiments, the multi-layered silicone composite has a thickness of 2 mils to 500 mils.

In some embodiments, the adhesive layer has a thickness of 1 mil to 200 mils.

Some embodiments relate to a method of installation. In some embodiments, the method of installation comprises obtaining a roofing membrane. In some embodiments, the roofing membrane comprises a multi-layered silicone composite. In some embodiments, the multi-layered silicone composite comprises a cured silicone top layer. In some embodiments, the cured silicone top layer does not have a foam structure. In some embodiments, the multi-layer silicone composite comprises at least one cured silicone core layer. In some embodiments, the at least one cured silicone core layer is located on the cured silicone top layer. In some embodiments, the at least one cured silicone core layer has a foam structure. In some embodiments, the cured silicone top layer has a thickness that is at least 50% less than a total thickness of the multi-layered silicone composite. In some embodiments, the roofing membrane comprises an adhesive layer. In some embodiments, the at least one cured silicone core layer is located between the adhesive layer and the cured silicone top layer. In some embodiments, the roofing membrane comprises a release liner. In some embodiments, the release liner covers the adhesive layer. In some embodiments, the method of installation comprises removing the release liner from the roofing membrane, so as to expose the adhesive layer. In some embodiments, the method of installation comprises contacting the adhesive layer of the roofing membrane to a roofing substrate, so as to adhere the roofing membrane to the roofing substrate.

In some embodiments, the roofing substrate comprises at least one of a plywood substrate, a glass substrate, a cellulosic substrate, a roof shingle, a mat, a fabric, a glass mat, a fiberglass mat, an underlayment, a roofing membrane, a roof deck, a photovoltaic (PV) panel, a modified bitumen (MODBIT) material, a roll good, a polyisocyanurate (ISO) foam board, a cover board, a pipe, a base sheet, a chimney, a wax paper, or any combination thereof.

### BRIEF DESCRIPTION OF THE DRAWINGS

Reference is made to the drawings that form a part of this disclosure, and which illustrate embodiments in which the materials and methods described herein can be practiced.

FIG. 1 illustrates a cross-section of a roofing membrane, according to some embodiments.

FIG. 2 is a flowchart of a method of installing a roofing membrane, according to some embodiments.

FIGS. 3A-3B are a flowchart of a method of manufacturing a roofing membrane, according to some embodiments.

### DETAILED DESCRIPTION

Some embodiments relate to silicone roofing membranes and related systems, methods, and composites. In some embodiments, a silicone roofing membrane is constructed of at least one cured silicone core layer and a cured silicone top layer. In some embodiments, the cured silicone top layer is different from the at least one cured silicone core layer, such that a silicone roofing membrane is obtained with desired properties and/or functionalities. In some embodiments, for example, the cured silicone core layers are formed with a foam structure that provides thermal insulation and/or impact resistance. In some embodiments, the manufacture of the silicone roofing membrane with one or more silicone core layers permits tuning of the membrane thickness. In some embodiments, the cured silicone top layer is formed without the foam structure, so as to provide a barrier (e.g., an air barrier, a water barrier, etc.) to environmental elements.

In some embodiments, the roofing membrane comprises a multi-layered silicone composite.

As used herein, the term “multi-layered silicone composite” refers to a composite comprising at least two layers of a silicone. In some embodiments, the term “multi-layered silicone composite” refers to a composite which is not an extrudate. In some embodiments, at least two of the at least two layers of the silicone composite are the same. In some embodiments, at least two of the at least two layers of the silicone composite are different. In some embodiments, the multi-layered silicone composite comprises at least two layers of a cured silicone. As used herein, the term “cured” refers to an at least partially crosslinked polymeric material. In some embodiments, the term “multi-layered silicone composite” refers to a multi-layered composite in which each layer is independently cured. For example, in some embodiments, each layer of the multi-layered silicone composite is applied to a surface and cured (or at least partially cured), before another layer of the multi-layered silicone composite is applied thereon and cured (or at least partially cured). In some embodiments, the roofing membrane comprises a silicone composite.

In some embodiments, the multi-layered silicone composite has a thickness of 2 mils to 500 mils. In some embodiments, the multi-layered silicone composite has a thickness of 10 mils to 500 mils. In some embodiments, the multi-layered silicone composite has a thickness of 20 mils to 500 mils. In some embodiments, the multi-layered silicone composite has a thickness of 40 mils to 500 mils. In some embodiments, the multi-layered silicone composite has a thickness of 60 mils to 500 mils. In some embodiments, the multi-layered silicone composite has a thickness of 80 mils to 500 mils. In some embodiments, the multi-layered silicone composite has a thickness of 100 mils to 500 mils. In some embodiments, the multi-layered silicone composite has a thickness of 120 mils to 500 mils. In some embodiments, the multi-layered silicone composite has a thickness of 140 mils to 500 mils. In some embodiments, the multi-layered silicone composite has a thickness of 160 mils to 500 mils. In some embodiments, the multi-layered silicone composite has a thickness of 180 mils to 500 mils. In some embodiments, the multi-layered silicone composite has a thickness of 200 mils to 500 mils.

In some embodiments, the multi-layered silicone composite has a thickness of 220 mils to 500 mils. In some embodiments, the multi-layered silicone composite has a thickness of 240 mils to 500 mils. In some embodiments, the multi-layered silicone composite has a thickness of 260 mils to 500 mils. In some embodiments, the multi-layered silicone composite has a thickness of 280 mils to 500 mils. In some embodiments, the multi-layered silicone composite has a thickness of 300 mils to 500 mils. In some embodiments, the multi-layered silicone composite has a thickness of 320 mils to 500 mils. In some embodiments, the multi-layered silicone composite has a thickness of 340 mils to 500 mils. In some embodiments, the multi-layered silicone composite has a thickness of 360 mils to 500 mils. In some embodiments, the multi-layered silicone composite has a thickness of 380 mils to 500 mils. In some embodiments, the multi-layered silicone composite has a thickness of 400 mils to 500 mils. In some embodiments, the multi-layered silicone composite has a thickness of 420 mils to 500 mils. In some embodiments, the multi-layered silicone composite has a thickness of 440 mils to 500 mils. In some embodiments, the multi-layered silicone composite has a thickness of 460 mils to 500 mils. In some embodiments, the multi-layered silicone composite has a thickness of 480 mils to 500 mils.

In some embodiments, the multi-layered silicone composite has a thickness of 2 mils to 480 mils. In some embodiments, the multi-layered silicone composite has a thickness of 2 mils to 460 mils. In some embodiments, the multi-layered silicone composite has a thickness of 2 mils to 440 mils. In some embodiments, the multi-layered silicone composite has a thickness of 2 mils to 420 mils. In some embodiments, the multi-layered silicone composite has a thickness of 2 mils to 400 mils. In some embodiments, the multi-layered silicone composite has a thickness of 2 mils to 380 mils. In some embodiments, the multi-layered silicone composite has a thickness of 2 mils to 360 mils. In some embodiments, the multi-layered silicone composite has a thickness of 2 mils to 340 mils. In some embodiments, the multi-layered silicone composite has a thickness of 2 mils to 320 mils. In some embodiments, the multi-layered silicone composite has a thickness of 2 mils to 300 mils.

In some embodiments, the multi-layered silicone composite has a thickness of 2 mils to 280 mils. In some embodiments, the multi-layered silicone composite has a thickness of 2 mils to 260 mils. In some embodiments, the multi-layered silicone composite has a thickness of 2 mils to 240 mils. In some embodiments, the multi-layered silicone composite has a thickness of 2 mils to 220 mils. In some embodiments, the multi-layered silicone composite has a thickness of 2 mils to 200 mils. In some embodiments, the multi-layered silicone composite has a thickness of 2 mils to 180 mils. In some embodiments, the multi-layered silicone composite has a thickness of 2 mils to 160 mils. In some embodiments, the multi-layered silicone composite has a thickness of 2 mils to 140 mils. In some embodiments, the multi-layered silicone composite has a thickness of 2 mils to 120 mils. In some embodiments, the multi-layered silicone composite has a thickness of 2 mils to 100 mils. In some embodiments, the multi-layered silicone composite has a thickness of 2 mils to 80 mils. In some embodiments, the multi-layered silicone composite has a thickness of 2 mils to 60 mils. In some embodiments, the multi-layered silicone composite has a thickness of 2 mils to 40 mils. In some embodiments, the multi-layered silicone composite has a thickness of 2 mils to 20 mils. In some embodiments, the multi-layered silicone composite has a thickness of 2 mils to 10 mils.

In some embodiments, the multi-layered silicone composite comprises a cured silicone top layer. As used herein, the term “top layer” refers to a layer which is the outermost layer of the roofing membrane. In some embodiments, the multi-layered silicone composite comprises at least one cured silicone core layer which contacts the cured silicone top layer. As used herein, the term “core layer” refers to a layer which is not the outermost layer of the roofing membrane. In some embodiments, the at least one cured silicone core layer comprises only one cured silicone layer. In some embodiments, the at least one cured silicone core layer comprises two or more cured silicone layers. For example, in some embodiments, the at least one cured silicone core layer comprises at least one of a first cured silicone core layer, a second cured silicone core layer, a third cured silicone core layer, a fourth cured silicone core layer, a fifth cured silicone core layer, a sixth cured silicone core layer, a seventh cured silicone core layer, an eight cured silicone core layer, a ninth cured silicone core layer, a tenth cured silicone core layer, or any combination thereof, up to one-hundred cured silicone core layers.

In some embodiments, the cured silicone top layer is located on the at least one cured silicone core layer. In some embodiments, the cured silicone top layer directly contacts the at least one cured silicone core layer.

In some embodiments, the cured silicone top layer is different from the at least one cured silicone core layer. In some embodiments, the cured silicone top layer has a different chemical composition than the at least one cured silicone core layer. In some embodiments, the cured silicone top layer has a different structure than the at least one cured silicone core layer. In some embodiments, the different structure is due to a different curing method. In some embodiments, the different structure is due to a different curing time. In some embodiments, the different structure is due to a different catalyst. In some embodiments, the different structure is due to a different chemical composition. In some embodiments, the cured silicone top layer has at least one different property than the at least one cured silicone core layer. In some embodiments, the different property is due to a foamed and/or non-foamed structure. In some embodiments, the different property is a mechanical property. In some embodiments, the different property is a structural property. In some embodiments, the at least one cured silicone core layer is same or similar to the cured silicone top layer. For example, in some embodiments, any one or more of the foregoing are same or similar in the at least one cured silicone core layer and the cured silicone top layer.

In some embodiments, the at least one cured silicone core layer has a foam structure. In some embodiments, the foam structure of the at least one cured silicone core layer is a closed cell foam. In some embodiments, the foam structure of the at least one cured silicone core layer is an open cell foam. In some embodiments, the at least one cured silicone core layer does not have a foam structure. In some embodiments, the cured silicone top layer does not have a foam structure. In some embodiments, the cured silicone top layer has a foam structure. In some embodiments, the foam structure of the cured silicone top layer is a closed cell foam. In some embodiments, the foam structure of the cured silicone top layer is an open cell foam.

In some embodiments, a density of the at least one cured silicone core layer is less than a density of the cured silicone top layer. In some embodiments, the density of the at least one cured silicone core layer is 0.4 g cm 3 to 2 g cm⁻³. In some embodiments, the density of the at least one cured silicone core layer is 0.5 g cm⁻³ to 2 g cm⁻³. In some embodiments, the density of the at least one cured silicone core layer is 0.6 g cm⁻³ to 2 g cm⁻³. In some embodiments, the density of the at least one cured silicone core layer is 0.7 g cm⁻³ to 2 g cm⁻³. In some embodiments, the density of the at least one cured silicone core layer is 0.8 g cm⁻³ to 2 g cm⁻³. In some embodiments, the density of the at least one cured silicone core layer is 0.9 g cm⁻³ to 2 g cm⁻³. In some embodiments, the density of the at least one cured silicone core layer is 1 g cm⁻³ to 2 g cm⁻³. In some embodiments, the density of the at least one cured silicone core layer is 1.1 g cm⁻³ to 2 g cm⁻³. In some embodiments, the density of the at least one cured silicone core layer is 1.2 g cm⁻³ to 2 g cm⁻³. In some embodiments, the density of the at least one cured silicone core layer is 1.3 g cm⁻³ to 2 g cm⁻³. In some embodiments, the density of the at least one cured silicone core layer is 1.4 g cm⁻³ to 2 g cm⁻³. In some embodiments, the density of the at least one cured silicone core layer is 1.5 g cm⁻³ to 2 g cm⁻³. In some embodiments, the density of the at least one cured silicone core layer is 1.6 g cm⁻³ to 2 g cm⁻³. In some embodiments, the density of the at least one cured silicone core layer is 1.7 g cm⁻³ to 2 g cm⁻³. In some embodiments, the density of the at least one cured silicone core layer is 1.8 g cm⁻³ to 2 g cm⁻³. In some embodiments, the density of the at least one cured silicone core layer is 1.9 g cm⁻³ to 2 g cm⁻³.

In some embodiments, the density of the at least one cured silicone core layer is 0.4 g cm⁻³ to 1.9 g cm⁻³. In some embodiments, the density of the at least one cured silicone core layer is 0.4 g cm 3 to 1.8 g cm⁻³. In some embodiments, the density of the at least one cured silicone core layer is 0.4 g cm⁻³ to 1.7 g cm⁻³. In some embodiments, the density of the at least one cured silicone core layer is 0.4 g cm⁻³ to 1.6 g cm⁻³. In some embodiments, the density of the at least one cured silicone core layer is 0.4 g cm⁻³ to 1.5 g cm⁻³. In some embodiments, the density of the at least one cured silicone core layer is 0.4 g cm⁻³ to 1.4 g cm⁻³. In some embodiments, the density of the at least one cured silicone core layer is 0.4 g cm⁻³ to 1.3 g cm⁻³. In some embodiments, the density of the at least one cured silicone core layer is 0.4 g cm⁻³ to 1.2 g cm⁻³. In some embodiments, the density of the at least one cured silicone core layer is 0.4 g cm⁻³ to 1.1 g cm⁻³. In some embodiments, the density of the at least one cured silicone core layer is 0.4 g cm⁻³ to 1 g cm⁻³. In some embodiments, the density of the at least one cured silicone core layer is 0.4 g cm⁻³ to 0.9 g cm⁻³. In some embodiments, the density of the at least one cured silicone core layer is 0.4 g cm⁻³ to 0.8 g cm⁻³. In some embodiments, the density of the at least one cured silicone core layer is 0.4 g cm⁻³ to 0.7 g cm⁻³. In some embodiments, the density of the at least one cured silicone core layer is 0.4 g cm⁻³ to 0.6 g cm⁻³. In some embodiments, the density of the at least one cured silicone core layer is 0.4 g cm⁻³ to 0.5 g cm⁻³.

In some embodiments, the cured silicone top layer has a thickness of 1 mil to 499 mils. In some embodiments, the cured silicone top layer has a thickness of 10 mils to 499 mils. In some embodiments, the cured silicone top layer has a thickness of 20 mils to 499 mils. In some embodiments, the cured silicone top layer has a thickness of 40 mils to 499 mils. In some embodiments, the cured silicone top layer has a thickness of 60 mils to 499 mils. In some embodiments, the cured silicone top layer has a thickness of 80 mils to 499 mils. In some embodiments, the cured silicone top layer has a thickness of 100 mils to 499 mils. In some embodiments, the cured silicone top layer has a thickness of 110 mils to 499 mils. In some embodiments, the cured silicone top layer has a thickness of 120 mils to 499 mils. In some embodiments, the cured silicone top layer has a thickness of 140 mils to 499 mils. In some embodiments, the cured silicone top layer has a thickness of 160 mils to 499 mils. In some embodiments, the cured silicone top layer has a thickness of 180 mils to 499 mils. In some embodiments, the cured silicone top layer has a thickness of 200 mils to 499 mils.

In some embodiments, the cured silicone top layer has a thickness of 220 mils to 499 mils. In some embodiments, the cured silicone top layer has a thickness of 240 mils to 499 mils. In some embodiments, the cured silicone top layer has a thickness of 260 mils to 499 mils. In some embodiments, the cured silicone top layer has a thickness of 280 mils to 499 mils. In some embodiments, the cured silicone top layer has a thickness of 300 mils to 499 mils. In some embodiments, the cured silicone top layer has a thickness of 320 mils to 499 mils. In some embodiments, the cured silicone top layer has a thickness of 340 mils to 499 mils. In some embodiments, the cured silicone top layer has a thickness of 360 mils to 499 mils. In some embodiments, the cured silicone top layer has a thickness of 380 mils to 499 mils. In some embodiments, the cured silicone top layer has a thickness of 400 mils to 499 mils. In some embodiments, the cured silicone top layer has a thickness of 420 mils to 499 mils. In some embodiments, the cured silicone top layer has a thickness of 440 mils to 499 mils. In some embodiments, the cured silicone top layer has a thickness of 460 mils to 499 mils. In some embodiments, the cured silicone top layer has a thickness of 480 mils to 499 mils.

In some embodiments, the cured silicone top layer has a thickness of 1 mil to 480 mils. In some embodiments, the cured silicone top layer has a thickness of 1 mil to 460 mils. In some embodiments, the cured silicone top layer has a thickness of 1 mil to 440 mils. In some embodiments, the cured silicone top layer has a thickness of 1 mil to 420 mils. In some embodiments, the cured silicone top layer has a thickness of 1 mil to 400 mils. In some embodiments, the cured silicone top layer has a thickness of 1 mil to 380 mils. In some embodiments, the cured silicone top layer has a thickness of 1 mil to 360 mils. In some embodiments, the cured silicone top layer has a thickness of 1 mil to 340 mils. In some embodiments, the cured silicone top layer has a thickness of 1 mil to 320 mils. In some embodiments, the cured silicone top layer has a thickness of 1 mil to 300 mils.

In some embodiments, the cured silicone top layer has a thickness of 1 mil to 280 mils. In some embodiments, the cured silicone top layer has a thickness of 1 mil to 260 mils. In some embodiments, the cured silicone top layer has a thickness of 1 mil to 240 mils. In some embodiments, the cured silicone top layer has a thickness of 1 mil to 220 mils. In some embodiments, the cured silicone top layer has a thickness of 1 mil to 200 mils. In some embodiments, the cured silicone top layer has a thickness of 1 mil to 180 mils. In some embodiments, the cured silicone top layer has a thickness of 1 mil to 160 mils. In some embodiments, the cured silicone top layer has a thickness of 1 mil to 140 mils. In some embodiments, the cured silicone top layer has a thickness of 1 mil to 120 mils. In some embodiments, the cured silicone top layer has a thickness of 1 mil to 100 mils. In some embodiments, the cured silicone top layer has a thickness of 1 mil to 80 mils. In some embodiments, the cured silicone top layer has a thickness of 1 mil to 60 mils. In some embodiments, the cured silicone top layer has a thickness of 1 mil to 40 mils. In some embodiments, the cured silicone top layer has a thickness of 1 mil to 20 mils. In some embodiments, the cured silicone top layer has a thickness of 1 mil to 10 mils.

In some embodiments, the at least one cured silicone core layer has a thickness of 1 mil to 499 mils. In some embodiments, the at least one cured silicone core layer has a thickness of 10 mils to 499 mils. In some embodiments, the at least one cured silicone core layer has a thickness of 20 mils to 499 mils. In some embodiments, the at least one cured silicone core layer has a thickness of 40 mils to 499 mils. In some embodiments, the at least one cured silicone core layer has a thickness of 60 mils to 499 mils. In some embodiments, the at least one cured silicone core layer has a thickness of 80 mils to 499 mils. In some embodiments, the at least one cured silicone core layer has a thickness of 100 mils to 499 mils. In some embodiments, the at least one cured silicone core layer has a thickness of 110 mils to 499 mils. In some embodiments, the at least one cured silicone core layer has a thickness of 120 mils to 499 mils. In some embodiments, the at least one cured silicone core layer has a thickness of 140 mils to 499 mils. In some embodiments, the at least one cured silicone core layer has a thickness of 160 mils to 499 mils. In some embodiments, the at least one cured silicone core layer has a thickness of 180 mils to 499 mils. In some embodiments, the at least one cured silicone core layer has a thickness of 200 mils to 499 mils.

In some embodiments, the at least one cured silicone core layer has a thickness of 220 mils to 499 mils. In some embodiments, the at least one cured silicone core layer has a thickness of 240 mils to 499 mils. In some embodiments, the at least one cured silicone core layer has a thickness of 260 mils to 499 mils. In some embodiments, the at least one cured silicone core layer has a thickness of 280 mils to 499 mils. In some embodiments, the at least one cured silicone core layer has a thickness of 300 mils to 499 mils. In some embodiments, the at least one cured silicone core layer has a thickness of 320 mils to 499 mils. In some embodiments, the at least one cured silicone core layer has a thickness of 340 mils to 499 mils. In some embodiments, the at least one cured silicone core layer has a thickness of 360 mils to 499 mils. In some embodiments, the at least one cured silicone core layer has a thickness of 380 mils to 499 mils. In some embodiments, the at least one cured silicone core layer has a thickness of 400 mils to 499 mils. In some embodiments, the at least one cured silicone core layer has a thickness of 420 mils to 499 mils. In some embodiments, the at least one cured silicone core layer has a thickness of 440 mils to 499 mils. In some embodiments, the at least one cured silicone core layer has a thickness of 460 mils to 499 mils. In some embodiments, the at least one cured silicone core layer has a thickness of 480 mils to 499 mils.

In some embodiments, the at least one cured silicone core layer has a thickness of 1 mil to 480 mils. In some embodiments, the at least one cured silicone core layer has a thickness of 1 mil to 460 mils. In some embodiments, the at least one cured silicone core layer has a thickness of 1 mil to 440 mils. In some embodiments, the at least one cured silicone core layer has a thickness of 1 mil to 420 mils. In some embodiments, the at least one cured silicone core layer has a thickness of 1 mil to 400 mils. In some embodiments, the at least one cured silicone core layer has a thickness of 1 mil to 380 mils. In some embodiments, the at least one cured silicone core layer has a thickness of 1 mil to 360 mils. In some embodiments, the at least one cured silicone core layer has a thickness of 1 mil to 340 mils. In some embodiments, the at least one cured silicone core layer has a thickness of 1 mil to 320 mils. In some embodiments, the at least one cured silicone core layer has a thickness of 1 mil to 300 mils.

In some embodiments, the at least one cured silicone core layer has a thickness of 1 mil to 280 mils. In some embodiments, the at least one cured silicone core layer has a thickness of 1 mil to 260 mils. In some embodiments, the at least one cured silicone core layer has a thickness of 1 mil to 240 mils. In some embodiments, the at least one cured silicone core layer has a thickness of 1 mil to 220 mils. In some embodiments, the at least one cured silicone core layer has a thickness of 1 mil to 200 mils. In some embodiments, the at least one cured silicone core layer has a thickness of 1 mil to 180 mils. In some embodiments, the at least one cured silicone core layer has a thickness of 1 mil to 160 mils. In some embodiments, the at least one cured silicone core layer has a thickness of 1 mil to 140 mils. In some embodiments, the at least one cured silicone core layer has a thickness of 1 mil to 120 mils. In some embodiments, the at least one cured silicone core layer has a thickness of 1 mil to 100 mils. In some embodiments, the at least one cured silicone core layer has a thickness of 1 mil to 80 mils. In some embodiments, the at least one cured silicone core layer has a thickness of 1 mil to 60 mils. In some embodiments, the at least one cured silicone core layer has a thickness of 1 mil to 40 mils. In some embodiments, the at least one cured silicone core layer has a thickness of 1 mil to 20 mils. In some embodiments, the at least one cured silicone core layer has a thickness of 1 mil to 10 mils.

In some embodiments, the roofing membrane comprises an adhesive layer.

In some embodiments, the adhesive layer is located on the at least one cured silicone core layer. In some embodiments, the at least one cured silicone core layer is located between the cured silicone top layer and the adhesive layer. In some embodiments, the adhesive layer covers at least a portion of the at least one cured silicone core layer. In some embodiments, the adhesive layer covers only a portion of the at least one cured silicone core layer. In some embodiments, the adhesive layer covers the entire at least one cured silicone core layer. In some embodiments, the adhesive layer directly contacts the at least one cured silicone core layer. In some embodiments, the adhesive layer is bonded to the at least one cured silicone core layer. In some embodiments, an intervening layer is located between the adhesive layer and the at least one cured silicone core layer. In some embodiments, the adhesive layer is adhered to the at least one cured silicone core layer.

In some embodiments, the adhesive layer covers at least 10% of a surface of the at least one cured silicone core layer. In some embodiments, the adhesive layer covers at least 20% of a surface of the at least one cured silicone core layer. In some embodiments, the adhesive layer covers at least 30% of a surface of the at least one cured silicone core layer. In some embodiments, the adhesive layer covers at least 40% of a surface of the at least one cured silicone core layer. In some embodiments, the adhesive layer covers at least 50% of a surface of the at least one cured silicone core layer. In some embodiments, the adhesive layer covers at least 60% of a surface of the at least one cured silicone core layer. In some embodiments, the adhesive layer covers at least 70% of a surface of the at least one cured silicone core layer. In some embodiments, the adhesive layer covers at least 80% of a surface of the at least one cured silicone core layer. In some embodiments, the adhesive layer covers at least 90% of a surface of the at least one cured silicone core layer. In some embodiments, the adhesive layer covers at least 99% of a surface of the at least one cured silicone core layer. In some embodiments, the adhesive layer covers an entire surface of the at least one cured silicone core layer.

In some embodiments, the adhesive layer covers 10% to 99% of a surface of the at least one cured silicone core layer. In some embodiments, the adhesive layer covers 20% to 99% of a surface of the at least one cured silicone core layer. In some embodiments, the adhesive layer covers 30% to 99% of a surface of the at least one cured silicone core layer. In some embodiments, the adhesive layer covers 40% to 99% of a surface of the at least one cured silicone core layer. In some embodiments, the adhesive layer covers 50% to 99% of a surface of the at least one cured silicone core layer. In some embodiments, the adhesive layer covers 60% to 99% of a surface of the at least one cured silicone core layer. In some embodiments, the adhesive layer covers 70% to 99% of a surface of the at least one cured silicone core layer. In some embodiments, the adhesive layer covers 80% to 99% of a surface of the at least one cured silicone core layer. In some embodiments, the adhesive layer covers 90% to 99% of a surface of the at least one cured silicone core layer.

In some embodiments, the adhesive layer covers 10% to 90% of a surface of the at least one cured silicone core layer. In some embodiments, the adhesive layer covers 10% to 80% of a surface of the at least one cured silicone core layer. In some embodiments, the adhesive layer covers 10% to 70% of a surface of the at least one cured silicone core layer. In some embodiments, the adhesive layer covers 10% to 60% of a surface of the at least one cured silicone core layer. In some embodiments, the adhesive layer covers 10% to 50% of a surface of the at least one cured silicone core layer. In some embodiments, the adhesive layer covers 10% to 40% of a surface of the at least one cured silicone core layer. In some embodiments, the adhesive layer covers 10% to 30% of a surface of the at least one cured silicone core layer. In some embodiments, the adhesive layer covers 10% to 20% of a surface of the at least one cured silicone core layer.

In some embodiments, the adhesive layer has a thickness of 1 mil to 200 mils. In some embodiments, the adhesive layer has a thickness of 10 mil to 200 mils. In some embodiments, the adhesive layer has a thickness of 20 mil to 200 mils. In some embodiments, the adhesive layer has a thickness of 30 mil to 200 mils. In some embodiments, the adhesive layer has a thickness of 40 mil to 200 mils. In some embodiments, the adhesive layer has a thickness of 50 mil to 200 mils. In some embodiments, the adhesive layer has a thickness of 60 mil to 200 mils. In some embodiments, the adhesive layer has a thickness of 70 mil to 200 mils. In some embodiments, the adhesive layer has a thickness of 80 mil to 200 mils. In some embodiments, the adhesive layer has a thickness of 90 mil to 200 mils. In some embodiments, the adhesive layer has a thickness of 100 mil to 200 mils. In some embodiments, the adhesive layer has a thickness of 110 mil to 200 mils. In some embodiments, the adhesive layer has a thickness of 120 mil to 200 mils. In some embodiments, the adhesive layer has a thickness of 130 mil to 200 mils. In some embodiments, the adhesive layer has a thickness of 140 mil to 200 mils. In some embodiments, the adhesive layer has a thickness of 150 mil to 200 mils. In some embodiments, the adhesive layer has a thickness of 160 mil to 200 mils. In some embodiments, the adhesive layer has a thickness of 170 mil to 200 mils. In some embodiments, the adhesive layer has a thickness of 180 mil to 200 mils. In some embodiments, the adhesive layer has a thickness of 190 mil to 200 mils.

In some embodiments, the adhesive layer has a thickness of 1 mil to 190 mils. In some embodiments, the adhesive layer has a thickness of 1 mil to 180 mils. In some embodiments, the adhesive layer has a thickness of 1 mil to 170 mils. In some embodiments, the adhesive layer has a thickness of 1 mil to 160 mils. In some embodiments, the adhesive layer has a thickness of 1 mil to 150 mils. In some embodiments, the adhesive layer has a thickness of 1 mil to 140 mils. In some embodiments, the adhesive layer has a thickness of 1 mil to 130 mils. In some embodiments, the adhesive layer has a thickness of 1 mil to 120 mils. In some embodiments, the adhesive layer has a thickness of 1 mil to 110 mils. In some embodiments, the adhesive layer has a thickness of 1 mil to 100 mils. In some embodiments, the adhesive layer has a thickness of 1 mil to 90 mils. In some embodiments, the adhesive layer has a thickness of 1 mil to 80 mils. In some embodiments, the adhesive layer has a thickness of 1 mil to 70 mils. In some embodiments, the adhesive layer has a thickness of 1 mil to 60 mils. In some embodiments, the adhesive layer has a thickness of 1 mil to 50 mils. In some embodiments, the adhesive layer has a thickness of 1 mil to 40 mils. In some embodiments, the adhesive layer has a thickness of 1 mil to 30 mils. In some embodiments, the adhesive layer has a thickness of 1 mil to 20 mils. In some embodiments, the adhesive layer has a thickness of 1 mil to 10 mils.

In some embodiments, the adhesive layer comprises at least one adhesive. In some embodiments, the at least one adhesive comprises at least one of a hot melt adhesive, a solvent-based adhesive, a pressure sensitive adhesive, a water-based adhesive, a UV cured or UV curable polymer, or any combination thereof. In some embodiments, the at least one adhesive comprises at least one of an asphaltic adhesive, a butyl adhesive, a silicone adhesive, an acrylic adhesive, a synthetic thermoplastic elastomer, a natural rubber, or any combination thereof. In some embodiments, the at least one adhesive comprises at least one of thermosetting polyolefin, thermoplastic polyolefin (TPO), polyvinyl butyrate, silicone, polycarbonate, butyl rubber, styrene-butadiene-styrene (SBS), styrene-isoprene-styrene (SIS), styrene butadiene (SB), styrene-ethylene-butadiene-styrene (SEBS), ethylene vinyl acetate (EVA), a resin, a hydrocarbon resin, a rosin resin, a natural wax, a petroleum wax, an oil, bitumen, a solvent, vinyl acetate, an acrylic polymers, an acrylic copolymer, (e.g., at least one of vinyl acetate acrylic, ethylene vinyl acetate, styrene acrylic, vinyl chloride acrylic, vinyl versatate, or any combination thereof), or any combination thereof. In some embodiments, the at least one adhesive comprises at one elastomer. In some embodiments, the at least one elastomer comprises at least one of a butyl rubber, a styrenic block copolymer, or any combination thereof.

In some embodiments, the at least one adhesive comprises at least one of an asphaltic adhesive, a butyl adhesive, a silicone adhesive, an epoxy adhesive, a polyurethane adhesive, an acrylic adhesive, or any combination thereof. In some embodiments, the at least one adhesive comprises at least one of thermosetting polyolefin, thermoplastic polyolefin (TPO), polyvinyl butyrate, silicone, polycarbonate, butyl rubber, styrene, styrene-butadiene-styrene (SBS), styrene-isoprene-styrene (SIS), styrene butadiene (SB), styrene-ethylene-butadiene-styrene (SEBS), ethylene vinyl acetate (EVA), a resin, a hydrocarbon resin, a rosin resin, a natural wax, a petroleum wax, an oil, bitumen, a solvent, vinyl acetate, an acrylic polymer, an acrylic copolymer, (e.g., at least one of vinyl acetate acrylic, ethylene vinyl acetate, an ethylene acrylic, styrene acrylic, vinyl chloride acrylic, vinyl versatate, or any combination thereof), a silyl modified polymer, a silane terminated polymer, natural rubber, a polyolefin polymer, a poly-alpha-olefin (APAO/APO) polymer, a polyamide polyvinyl acetate, a polyvinyl alcohol, a polyamide, a polyester, a polyester amide, or any combination thereof.

In some embodiments, the roofing membrane comprises a release liner. In some embodiments, a release liner covers at least a portion of the adhesive layer. In some embodiments, a release liner covers an entire surface of the adhesive layer. In some embodiments, a release liner covers at least a portion of the cured silicone top layer. In some embodiments, a release liner covers an entire surface of the cured silicone top layer. In some embodiments, a first release liner covers the cured silicone top layer and a second release liner covers the adhesive layer.

In some embodiments, the roofing membrane comprises a reinforcement layer having a first surface and a second surface opposite the first surface. As used herein, the term “reinforcement layer” refers to any layer which is not a multi-layered silicone composite as disclosed herein and/or which is not an adhesive layer as disclosed herein. In some embodiments, the reinforcement layer is a support layer. In some embodiments, the reinforcement layer comprises at least one of a mesh, a fabric, a fleece, a mat, a scrim, a coated scrim, a woven, a non-woven, or any combination thereof. In some embodiments, the reinforcement layer comprises at least one of a spunbond mat, a spunlaced mat, an airlaid mat, a meltblown mat, or any combination thereof. In some embodiments, the reinforcement layer comprises a fibrous material, wherein the fibrous material comprises at least one of a natural fiber, a synthetic fiber, or any combination thereof. In some embodiments, the reinforcement layer comprises at least one of a polyolefin (e.g., at least one of a polyethylene, a polypropylene, any copolymer thereof, any blend thereof, or any combination thereof), a polyester, a polyamide, a glass, a fiberglass, or any combination thereof. In some embodiments, the roofing membrane does not comprise a reinforcement layer.

In some embodiments, the reinforcement layer has a thickness of 1 mil to 200 mils. In some embodiments, the reinforcement layer has a thickness of 10 mils to 200 mils. In some embodiments, the reinforcement layer has a thickness of 20 mils to 200 mils. In some embodiments, the reinforcement layer has a thickness of 30 mils to 200 mils. In some embodiments, the reinforcement layer has a thickness of 40 mils to 200 mils. In some embodiments, the reinforcement layer has a thickness of 50 mils to 200 mils. In some embodiments, the reinforcement layer has a thickness of 60 mils to 200 mils. In some embodiments, the reinforcement layer has a thickness of 70 mils to 200 mils. In some embodiments, the reinforcement layer has a thickness of 80 mils to 200 mils. In some embodiments, the reinforcement layer has a thickness of 90 mils to 200 mils. In some embodiments, the reinforcement layer has a thickness of 100 mils to 200 mils. In some embodiments, the reinforcement layer has a thickness of 110 mils to 200 mils. In some embodiments, the reinforcement layer has a thickness of 120 mils to 200 mils. In some embodiments, the reinforcement layer has a thickness of 130 mils to 200 mils. In some embodiments, the reinforcement layer has a thickness of 140 mils to 200 mils. In some embodiments, the reinforcement layer has a thickness of 150 mils to 200 mils. In some embodiments, the reinforcement layer has a thickness of 160 mils to 200 mils. In some embodiments, the reinforcement layer has a thickness of 170 mils to 200 mils. In some embodiments, the reinforcement layer has a thickness of 180 mils to 200 mils. In some embodiments, the reinforcement layer has a thickness of 190 mils to 200 mils.

In some embodiments, the reinforcement layer has a thickness of 1 mil to 190 mils. In some embodiments, the reinforcement layer has a thickness of 1 mil to 180 mils. In some embodiments, the reinforcement layer has a thickness of 1 mil to 170 mils. In some embodiments, the reinforcement layer has a thickness of 1 mil to 160 mils. In some embodiments, the reinforcement layer has a thickness of 1 mil to 150 mils. In some embodiments, the reinforcement layer has a thickness of 1 mil to 140 mils. In some embodiments, the reinforcement layer has a thickness of 1 mil to 130 mils. In some embodiments, the reinforcement layer has a thickness of 1 mil to 120 mils. In some embodiments, the reinforcement layer has a thickness of 1 mil to 110 mils. In some embodiments, the reinforcement layer has a thickness of 1 mil to 100 mils. In some embodiments, the reinforcement layer has a thickness of 1 mil to 90 mils. In some embodiments, the reinforcement layer has a thickness of 1 mil to 80 mils. In some embodiments, the reinforcement layer has a thickness of 1 mil to 70 mils. In some embodiments, the reinforcement layer has a thickness of 1 mil to 60 mils. In some embodiments, the reinforcement layer has a thickness of 1 mil to 50 mils. In some embodiments, the reinforcement layer has a thickness of 1 mil to 40 mils. In some embodiments, the reinforcement layer has a thickness of 1 mil to 30 mils. In some embodiments, the reinforcement layer has a thickness of 1 mil to 20 mils. In some embodiments, the reinforcement layer has a thickness of 1 mil to 10 mils.

In some embodiments, the multi-layered silicone composite is located on the first surface of the reinforcement layer. In some embodiments, the multi-layered silicone composite covers at least a portion of the first surface of the reinforcement layer. In some embodiments, the multi-layered silicone composite covers only a portion of the first surface of the reinforcement layer. In some embodiments, the multi-layered silicone composite covers an entire first surface of the reinforcement layer. In some embodiments, the multilayered silicone composite directly contacts the first surface of the reinforcement layer. In some embodiments, the multi-layered silicone composite is bonded to the first surface of the reinforcement layer. In some embodiments, an intervening layer is located between the multi-layered silicone composite and the first surface of the reinforcement layer. In some embodiments, the multi-layered silicone composite is adhered to the first surface of the reinforcement layer. In some embodiments, the multi-layered silicone composite impregnates the first surface of the reinforcement layer. In some embodiments, the multi-layered silicone composite is pressed into the first surface of the reinforcement layer.

In some embodiments, the multi-layered silicone composite is located on the second surface of the reinforcement layer. In some embodiments, the multi-layered silicone composite covers at least a portion of the second surface of the reinforcement layer. In some embodiments, the multi-layered silicone composite covers only a portion of the second surface of the reinforcement layer. In some embodiments, the multi-layered silicone composite covers an entire second surface of the reinforcement layer. In some embodiments, the multilayered silicone composite directly contacts the second surface of the reinforcement layer. In some embodiments, the multi-layered silicone composite is bonded to the second surface of the reinforcement layer. In some embodiments, an intervening layer is located between the multi-layered silicone composite and the second surface of the reinforcement layer. In some embodiments, the multi-layered silicone composite is adhered to the second surface of the reinforcement layer. In some embodiments, the multi-layered silicone composite impregnates the second surface of the reinforcement layer. In some embodiments, the multi-layered silicone composite is pressed into the second surface of the reinforcement layer.

In some embodiments, the multi-layered silicone composite covers at least 10% of a surface of the reinforcement layer. In some embodiments, the multi-layered silicone composite covers at least 20% of a surface of the reinforcement layer. In some embodiments, the multi-layered silicone composite covers at least 30% of a surface of the reinforcement layer. In some embodiments, the multi-layered silicone composite covers at least 40% of a surface of the reinforcement layer. In some embodiments, the multi-layered silicone composite covers at least 50% of a surface of the reinforcement layer. In some embodiments, the multi-layered silicone composite covers at least 60% of a surface of the reinforcement layer. In some embodiments, the multi-layered silicone composite covers at least 70% of a surface of the reinforcement layer. In some embodiments, the multi-layered silicone composite covers at least 80% of a surface of the reinforcement layer. In some embodiments, the multi-layered silicone composite covers at least 90% of a surface of the reinforcement layer. In some embodiments, the multi-layered silicone composite covers at least 99% of a surface of the reinforcement layer. In some embodiments, the multi-layered silicone composite covers an entire surface of the reinforcement layer.

In some embodiments, the multi-layered silicone composite covers 10% to 99% of a surface of the reinforcement layer. In some embodiments, the multi-layered silicone composite covers 20% to 99% of a surface of the reinforcement layer. In some embodiments, the multi-layered silicone composite covers 30% to 99% of a surface of the reinforcement layer. In some embodiments, the multi-layered silicone composite covers 40% to 99% of a surface of the reinforcement layer. In some embodiments, the multi-layered silicone composite covers 50% to 99% of a surface of the reinforcement layer. In some embodiments, the multi-layered silicone composite covers 60% to 99% of a surface of the reinforcement layer. In some embodiments, the multi-layered silicone composite covers 70% to 99% of a surface of the reinforcement layer. In some embodiments, the multi-layered silicone composite covers 80% to 99% of a surface of the reinforcement layer. In some embodiments, the multi-layered silicone composite covers 90% to 99% of a surface of the reinforcement layer.

In some embodiments, the multi-layered silicone composite covers 10% to 90% of a surface of the reinforcement layer. In some embodiments, the multi-layered silicone composite covers 10% to 80% of a surface of the reinforcement layer. In some embodiments, the multi-layered silicone composite covers 10% to 70% of a surface of the reinforcement layer. In some embodiments, the multi-layered silicone composite covers 10% to 60% of a surface of the reinforcement layer. In some embodiments, the multi-layered silicone composite covers 10% to 50% of a surface of the reinforcement layer. In some embodiments, the multi-layered silicone composite covers 10% to 40% of a surface of the reinforcement layer. In some embodiments, the multi-layered silicone composite covers 10% to 30% of a surface of the reinforcement layer. In some embodiments, the multi-layered silicone composite covers 10% to 20% of a surface of the reinforcement layer.

Some embodiments relate to a roofing system. In some embodiments, the roofing system comprises a roofing substrate. In some embodiments, the roofing substrate comprises at least one of an asphaltic substrate, a plywood substrate, a glass substrate, a cellulosic substrate, an underlayment, a roofing membrane (reinforced or unreinforced), a roof deck, a photovoltaic (PV) panel, a modified bitumen (MODBIT) material, an oriented strand board (OSB), a roll good, a board (such as but not limited to at least one of a foam board (e.g., a polyisocyanurate (ISO) foam board), a cover board, or any combination thereof), a fire retardant board, a hail resistant board, a high density cover board, a cement board, concrete, a base sheet, a pipe, a chimney, a wax paper, a roof shingle, a mat, a fabric, a glass mat, a fiberglass mat, a woven mat, a nonwoven a fabric, a polyester mat, a scrim, a coated scrim, or any combination thereof.

In some embodiments, the roofing system comprises a roofing membrane located on the roofing substrate. In some embodiments, the roofing membrane contacts the roofing substrate. In some embodiments, the roofing membrane directly contacts the roofing substrate. In some embodiments, the roofing membrane is adhered to the roofing substrate by the adhesive layer of the roofing membrane. Any of the roofing membranes disclosed herein may be used, without departing from the scope of this disclosure. For example, in some embodiments, the roofing membrane comprises at least one of a multi-layered silicone composite, an adhesive layer located on the multi-layered silicone composite, or any combination thereof. In some embodiments, the multi-layered silicone composite comprises a cured silicone top layer and at least one cured silicone core layer. In some embodiments, the at least one cured silicone core layer is located between the cured silicone top layer and the adhesive layer.

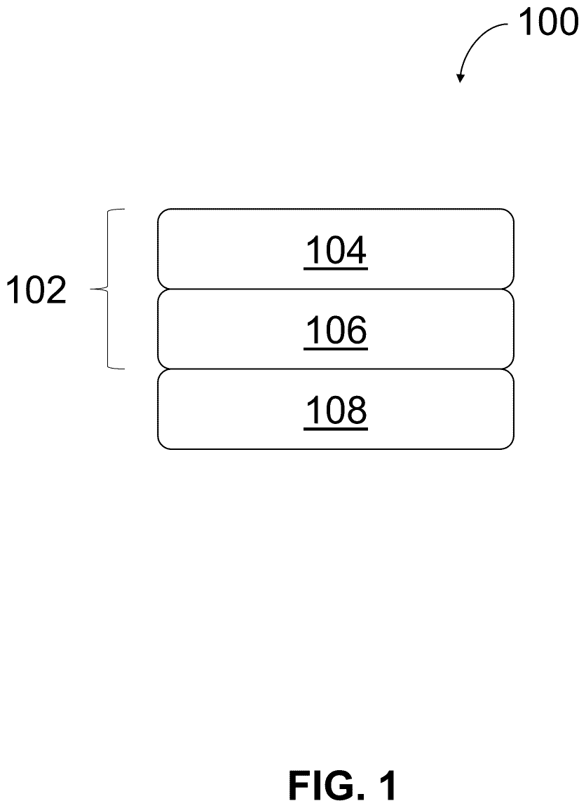

FIG. 1 is a cross-section of a roofing membrane 100, according to some embodiments. As shown in FIG. 1, in some embodiments, the roofing membrane 100 comprises a multi-layered silicone composite 102. In some embodiments, a multi-layered silicone composite 102 comprises a cured silicone top layer 104 and at least one cured silicone core layer 106. In some embodiments, an adhesive layer 108 is located on at least a portion of the at least one cured silicone core layer 106. Any of the multi-layered silicone composites and adhesive layers disclosed herein may be used without departing from the scope of this disclosure.

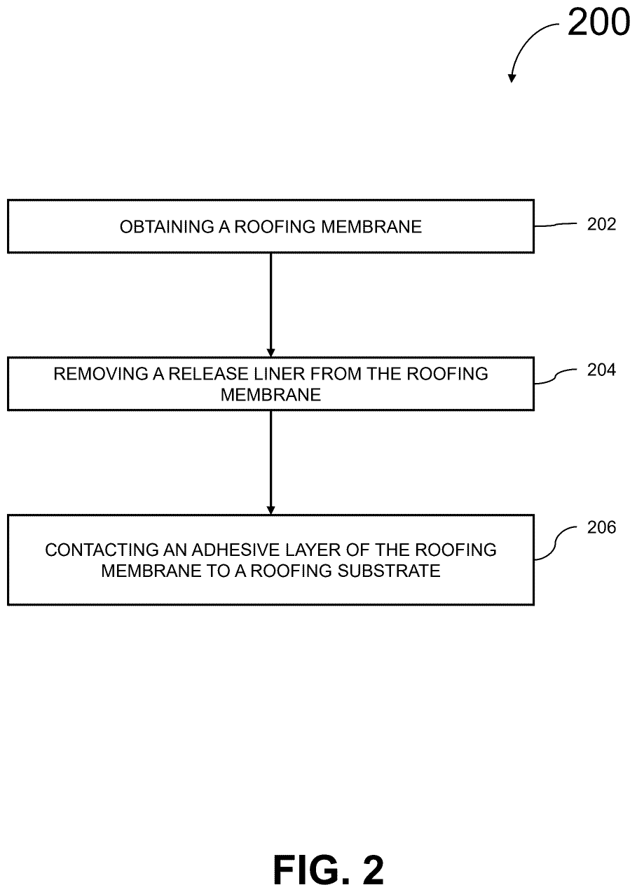

FIG. 2 is a flowchart of a method of installing 200 a roofing membrane, according to some embodiments. As shown in FIG. 2, in some embodiments, the method of installing 200 comprises one or more of the following steps: obtaining 202 a roofing membrane; removing 204 a release liner from the roofing membrane, so as to expose an adhesive layer; and contacting 206 the adhesive layer of the roofing membrane to a roofing substrate, so as to adhere the roofing membrane to the roofing substrate. Any of the roofing membranes and roofing substrates disclosed herein may be used without departing from the scope of this disclosure. In some embodiments, removing 204 comprises peeling the release liner from the roofing membrane. In some embodiments, removing 204 comprises pulling the release liner from the roofing membrane. In some embodiments, removing 204 comprises peeling, pulling, withdrawing, detaching, decoupling, or otherwise disassociating the release liner from the roofing membrane. In some embodiments, contacting 206 comprises bringing the adhesive layer of the roofing membrane into direct contact, or immediate or close proximity, to the roofing substrate. In some embodiments, contacting 206 comprises pressing the adhesive layer of the roofing membrane onto a surface of the roofing substrate. In some embodiments, contacting 206 comprises applying sufficient pressure to the adhesive layer of the roofing membrane so as to adhere the roofing membrane to the roofing substrate. In some embodiments, contacting 206 comprises heating the adhesive layer of the roofing membrane to a temperature sufficient to adhere the roofing membrane to the roofing substrate. In some embodiments, contacting 206 comprises removing an amount of a solvent from the adhesive layer of the roofing membrane sufficient to adhere the roofing membrane to the roofing substrate. In some embodiments, contacting 206 comprises exposing the adhesive layer of the roofing membrane to ultraviolet light.

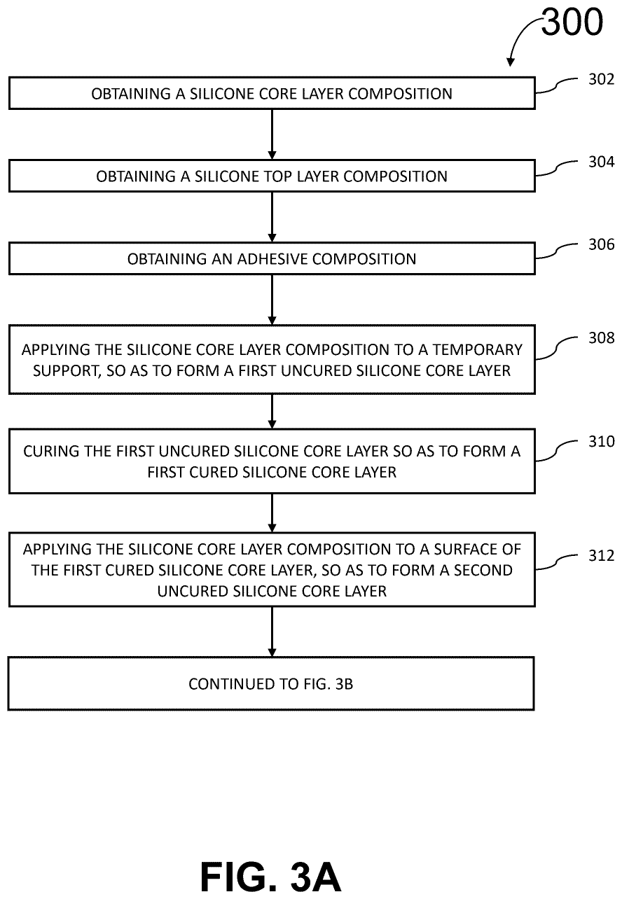

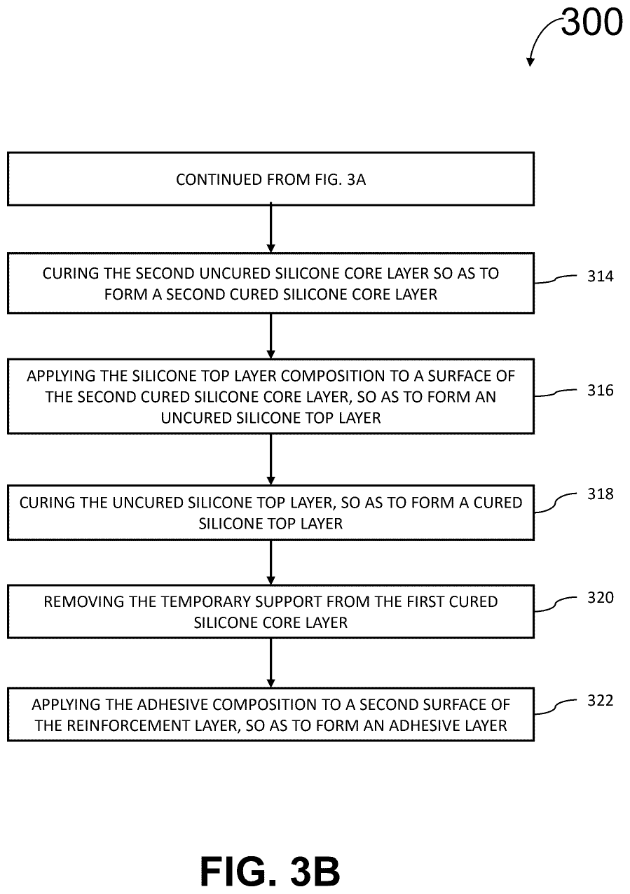

FIGS. 3A-3B are a flowchart of a method of manufacturing 300 a roofing membrane, according to some embodiments. As shown in FIGS. 3A-3B, in some embodiments, the method of manufacturing 300 comprises one or more of the following steps: obtaining 302 a silicone core layer composition; obtaining 304 a silicone top layer composition; obtaining 306 an adhesive composition; applying 308 the silicone core layer composition to a temporary support, so as to form a first uncured silicone core layer; curing 310 the first uncured silicone core layer so as to form a first cured silicone core layer; applying 312 the silicone core layer composition to a surface of the first cured silicone core layer, so as to form a second uncured silicone core layer; curing 314 the second uncured silicone core layer so as to form a second cured silicone core layer; applying 316 the silicone top layer composition to a surface of the second cured silicone core layer, so as to form an uncured silicone top layer; curing 318 the uncured silicone top layer, so as to form a cured silicone top layer; removing 320 the temporary support from the first cured silicone core layer; and applying 322 the adhesive composition to the first cured silicone core layer, so as to form an adhesive layer.

In some embodiments, the method of manufacturing 300 comprises applying 308 the silicone core layer composition to a temporary support, such as a release liner, so as to form a first uncured silicone core layer. In some embodiments, applying 308 comprises coating the silicone core layer composition onto the temporary support. In some embodiments, applying 308 comprises laminating the silicone core layer composition onto the temporary support. In some embodiments, applying 308 comprises extruding the silicone core layer composition onto the temporary support. In some embodiments, applying 308 comprises bonding the silicone core layer composition to temporary support. In some embodiments, applying 308 comprises pouring the silicone core layer composition onto the temporary support. In some embodiments, applying 31008 comprises disposing the silicone core layer composition onto the temporary support. In some embodiments, applying 308 comprises contacting the silicone core layer composition with the temporary support.

In some embodiments, the first uncured silicone core layer has a wet film thickness of 1 mil to 499 mils. In some embodiments, the first uncured silicone core layer has a wet film thickness of 10 mils to 499 mils. In some embodiments, the first uncured silicone core layer has a wet film thickness of 20 mils to 499 mils. In some embodiments, the first uncured silicone core layer has a wet film thickness of 40 mils to 499 mils. In some embodiments, the first uncured silicone core layer has a wet film thickness of 60 mils to 499 mils. In some embodiments, the first uncured silicone core layer has a wet film thickness of 80 mils to 499 mils. In some embodiments, the first uncured silicone core layer has a wet film thickness of 100 mils to 499 mils. In some embodiments, the first uncured silicone core layer has a wet film thickness of 110 mils to 499 mils. In some embodiments, the first uncured silicone core layer has a wet film thickness of 120 mils to 499 mils. In some embodiments, the first uncured silicone core layer has a wet film thickness of 140 mils to 499 mils. In some embodiments, the first uncured silicone core layer has a wet film thickness of 160 mils to 499 mils. In some embodiments, the first uncured silicone core layer has a wet film thickness of 180 mils to 499 mils. In some embodiments, the first uncured silicone core layer has a wet film thickness of 200 mils to 499 mils.

In some embodiments, the first uncured silicone core layer has a wet film thickness of 220 mils to 499 mils. In some embodiments, the first uncured silicone core layer has a wet film thickness of 240 mils to 499 mils. In some embodiments, the first uncured silicone core layer has a wet film thickness of 260 mils to 499 mils. In some embodiments, the first uncured silicone core layer has a wet film thickness of 280 mils to 499 mils. In some embodiments, the first uncured silicone core layer has a wet film thickness of 300 mils to 499 mils. In some embodiments, the first uncured silicone core layer has a wet film thickness of 320 mils to 499 mils. In some embodiments, the first uncured silicone core layer has a wet film thickness of 340 mils to 499 mils. In some embodiments, the first uncured silicone core layer has a wet film thickness of 360 mils to 499 mils. In some embodiments, the first uncured silicone core layer has a wet film thickness of 380 mils to 499 mils. In some embodiments, the first uncured silicone core layer has a wet film thickness of 400 mils to 499 mils. In some embodiments, the first uncured silicone core layer has a wet film thickness of 420 mils to 499 mils. In some embodiments, the first uncured silicone core layer has a wet film thickness of 440 mils to 499 mils. In some embodiments, the first uncured silicone core layer has a wet film thickness of 460 mils to 499 mils. In some embodiments, the first uncured silicone core layer has a wet film thickness of 480 mils to 499 mils.

In some embodiments, the first uncured silicone core layer has a wet film thickness of 1 mil to 480 mils. In some embodiments, the first uncured silicone core layer has a wet film thickness of 1 mil to 460 mils. In some embodiments, the first uncured silicone core layer has a wet film thickness of 1 mil to 440 mils. In some embodiments, the first uncured silicone core layer has a wet film thickness of 1 mil to 420 mils. In some embodiments, the first uncured silicone core layer has a wet film thickness of 1 mil to 400 mils. In some embodiments, the first uncured silicone core layer has a wet film thickness of 1 mil to 380 mils. In some embodiments, the first uncured silicone core layer has a wet film thickness of 1 mil to 360 mils. In some embodiments, the first uncured silicone core layer has a wet film thickness of 1 mil to 340 mils. In some embodiments, the first uncured silicone core layer has a wet film thickness of 1 mil to 320 mils. In some embodiments, the first uncured silicone core layer has a wet film thickness of 1 mil to 300 mils.

In some embodiments, the first uncured silicone core layer has a wet film thickness of 1 mil to 280 mils. In some embodiments, the first uncured silicone core layer has a wet film thickness of 1 mil to 260 mils. In some embodiments, the first uncured silicone core layer has a wet film thickness of 1 mil to 240 mils. In some embodiments, the first uncured silicone core layer has a wet film thickness of 1 mil to 220 mils. In some embodiments, the first uncured silicone core layer has a wet film thickness of 1 mil to 200 mils. In some embodiments, the first uncured silicone core layer has a wet film thickness of 1 mil to 180 mils. In some embodiments, the first uncured silicone core layer has a wet film thickness of 1 mil to 160 mils. In some embodiments, the first uncured silicone core layer has a wet film thickness of 1 mil to 140 mils. In some embodiments, the first uncured silicone core layer has a wet film thickness of 1 mil to 120 mils. In some embodiments, the first uncured silicone core layer has a wet film thickness of 1 mil to 100 mils. In some embodiments, the first uncured silicone core layer has a wet film thickness of 1 mil to 80 mils. In some embodiments, the first uncured silicone core layer has a wet film thickness of 1 mil to 60 mils. In some embodiments, the first uncured silicone core layer has a wet film thickness of 1 mil to 40 mils. In some embodiments, the first uncured silicone core layer has a wet film thickness of 1 mil to 20 mils. In some embodiments, the first uncured silicone core layer has a wet film thickness of 1 mil to 10 mils.

In some embodiments, the method of manufacturing 300 comprises curing 310 the first uncured silicone core layer so as to form a first cured silicone core layer. In some embodiments, curing 310 proceeds under conditions sufficient to at least partially cure the first uncured silicone core layer. In some embodiments, curing 310 proceeds under conditions sufficient to fully or at least substantially cure the first uncured silicone core layer. In some embodiments, curing 310 comprises heating for a duration sufficient to at least partially cure the first uncured silicone core layer. In some embodiments, curing 310 comprises heating for a duration sufficient to fully or at least substantially cure the first uncured silicone core layer. In some embodiments, curing 310 may comprise exposing to at least one of moisture, ultraviolet light, or other stimulus sufficient to induce curing.

In some embodiments, curing 310 comprises heating to a temperature of 80° C. to 400° C. In some embodiments, curing 310 comprises heating to a temperature of 80° C. to 380° C. In some embodiments, curing 310 comprises heating to a temperature of 80° C. to 360° C. In some embodiments, curing 310 comprises heating to a temperature of 80° C. to 340° C. In some embodiments, curing 310 comprises heating to a temperature of 80° C. to 320° C. In some embodiments, curing 310 comprises heating to a temperature of 80° C. to 300° C. In some embodiments, curing 310 comprises heating to a temperature of 80° C. to 280° C. In some embodiments, curing 310 comprises heating to a temperature of 80° C. to 260° C. In some embodiments, curing 310 comprises heating to a temperature of 80° C. to 240° C. In some embodiments, curing 310 comprises heating to a temperature of 80° C. to 220° C. In some embodiments, curing 310 comprises heating to a temperature of 80° C. to 200° C. In some embodiments, curing 310 comprises heating to a temperature of 80° C. to 180° C. In some embodiments, curing 310 comprises heating to a temperature of 80° C. to 160° C. In some embodiments, curing 310 comprises heating to a temperature of 80° C. to 140° C. In some embodiments, curing 310 comprises heating to a temperature of 80° C. to 120° C. In some embodiments, curing 310 comprises heating to a temperature of 80° C. to 100° C.

In some embodiments, curing 310 comprises heating to a temperature of 100° C. to 400° C. In some embodiments, curing 310 comprises heating to a temperature of 120° C. to 400° C. In some embodiments, curing 310 comprises heating to a temperature of 140° C. to 400° C. In some embodiments, curing 310 comprises heating to a temperature of 160° C. to 400° C. In some embodiments, curing 310 comprises heating to a temperature of 180° C. to 400° C. In some embodiments, curing 310 comprises heating to a temperature of 200° C. to 400° C. In some embodiments, curing 310 comprises heating to a temperature of 220° C. to 400° C. In some embodiments, curing 310 comprises heating to a temperature of 240° C. to 400° C. In some embodiments, curing 310 comprises heating to a temperature of 260° C. to 400° C. In some embodiments, curing 310 comprises heating to a temperature of 280° C. to 400° C. In some embodiments, curing 310 comprises heating to a temperature of 300° C. to 400° C. In some embodiments, curing 310 comprises heating to a temperature of 320° C. to 400° C. In some embodiments, curing 310 comprises heating to a temperature of 340° C. to 400° C. In some embodiments, curing 310 comprises heating to a temperature of 360° C. to 400° C. In some embodiments, curing 310 comprises heating to a temperature of 380° C. to 400° C.

It will be appreciated that steps 308 and 310 may be repeated one or more times until a desired thickness of the multi-layered silicone composite and/or the cured silicone core layer(s) is obtained.

In some embodiments, the method of manufacturing 300 comprises applying 312 the silicone core layer composition to a surface of the first cured silicone core layer, so as to form a second uncured silicone core layer. In some embodiments, applying 312 comprises composite the silicone core layer composition onto the surface of the first cured silicone core layer. In some embodiments, applying 312 comprises laminating the silicone core layer composition onto the surface of the first cured silicone core layer. In some embodiments, applying 312 comprises extruding the silicone core layer composition onto the surface of the first cured silicone core layer. In some embodiments, applying 312 comprises bonding the silicone core layer composition to the first surface of the reinforcement layer. In some embodiments, applying 312 comprises pouring the silicone core layer composition onto the surface of the first cured silicone core layer. In some embodiments, applying 312 comprises disposing the silicone core layer composition onto the surface of the first cured silicone core layer. In some embodiments, applying 312 comprises contacting the silicone core layer composition with the surface of the first cured silicone core layer.

In some embodiments, the second uncured silicone core layer has a wet film thickness of 1 mil to 499 mils. In some embodiments, the second uncured silicone core layer has a wet film thickness of 10 mils to 499 mils. In some embodiments, the second uncured silicone core layer has a wet film thickness of 20 mils to 499 mils. In some embodiments, the second uncured silicone core layer has a wet film thickness of 40 mils to 499 mils. In some embodiments, the second uncured silicone core layer has a wet film thickness of 60 mils to 499 mils. In some embodiments, the second uncured silicone core layer has a wet film thickness of 80 mils to 499 mils. In some embodiments, the second uncured silicone core layer has a wet film thickness of 100 mils to 499 mils. In some embodiments, the second uncured silicone core layer has a wet film thickness of 110 mils to 499 mils. In some embodiments, the second uncured silicone core layer has a wet film thickness of 120 mils to 499 mils. In some embodiments, the second uncured silicone core layer has a wet film thickness of 140 mils to 499 mils. In some embodiments, the second uncured silicone core layer has a wet film thickness of 160 mils to 499 mils. In some embodiments, the second uncured silicone core layer has a wet film thickness of 180 mils to 499 mils. In some embodiments, the second uncured silicone core layer has a wet film thickness of 200 mils to 499 mils.

In some embodiments, the second uncured silicone core layer has a wet film thickness of 220 mils to 499 mils. In some embodiments, the second uncured silicone core layer has a wet film thickness of 240 mils to 499 mils. In some embodiments, the second uncured silicone core layer has a wet film thickness of 260 mils to 499 mils. In some embodiments, the second uncured silicone core layer has a wet film thickness of 280 mils to 499 mils. In some embodiments, the second uncured silicone core layer has a wet film thickness of 300 mils to 499 mils. In some embodiments, the second uncured silicone core layer has a wet film thickness of 320 mils to 499 mils. In some embodiments, the second uncured silicone core layer has a wet film thickness of 340 mils to 499 mils. In some embodiments, the second uncured silicone core layer has a wet film thickness of 360 mils to 499 mils. In some embodiments, the second uncured silicone core layer has a wet film thickness of 380 mils to 499 mils. In some embodiments, the second uncured silicone core layer has a wet film thickness of 400 mils to 499 mils. In some embodiments, the second uncured silicone core layer has a wet film thickness of 420 mils to 499 mils. In some embodiments, the second uncured silicone core layer has a wet film thickness of 440 mils to 499 mils. In some embodiments, the second uncured silicone core layer has a wet film thickness of 460 mils to 499 mils. In some embodiments, the second uncured silicone core layer has a wet film thickness of 480 mils to 499 mils.

In some embodiments, the second uncured silicone core layer has a wet film thickness of 1 mil to 480 mils. In some embodiments, the second uncured silicone core layer has a wet film thickness of 1 mil to 460 mils. In some embodiments, the second uncured silicone core layer has a wet film thickness of 1 mil to 440 mils. In some embodiments, the second uncured silicone core layer has a wet film thickness of 1 mil to 420 mils. In some embodiments, the second uncured silicone core layer has a wet film thickness of 1 mil to 400 mils. In some embodiments, the second uncured silicone core layer has a wet film thickness of 1 mil to 380 mils. In some embodiments, the second uncured silicone core layer has a wet film thickness of 1 mil to 360 mils. In some embodiments, the second uncured silicone core layer has a wet film thickness of 1 mil to 340 mils. In some embodiments, the second uncured silicone core layer has a wet film thickness of 1 mil to 320 mils. In some embodiments, the second uncured silicone core layer has a wet film thickness of 1 mil to 300 mils.

In some embodiments, the second uncured silicone core layer has a wet film thickness of 1 mil to 280 mils. In some embodiments, the second uncured silicone core layer has a wet film thickness of 1 mil to 260 mils. In some embodiments, the second uncured silicone core layer has a wet film thickness of 1 mil to 240 mils. In some embodiments, the second uncured silicone core layer has a wet film thickness of 1 mil to 220 mils. In some embodiments, the second uncured silicone core layer has a wet film thickness of 1 mil to 200 mils. In some embodiments, the second uncured silicone core layer has a wet film thickness of 1 mil to 180 mils. In some embodiments, the second uncured silicone core layer has a wet film thickness of 1 mil to 160 mils. In some embodiments, the second uncured silicone core layer has a wet film thickness of 1 mil to 140 mils. In some embodiments, the second uncured silicone core layer has a wet film thickness of 1 mil to 120 mils. In some embodiments, the second uncured silicone core layer has a wet film thickness of 1 mil to 100 mils. In some embodiments, the second uncured silicone core layer has a wet film thickness of 1 mil to 80 mils. In some embodiments, the second uncured silicone core layer has a wet film thickness of 1 mil to 60 mils. In some embodiments, the second uncured silicone core layer has a wet film thickness of 1 mil to 40 mils. In some embodiments, the second uncured silicone core layer has a wet film thickness of 1 mil to 20 mils. In some embodiments, the second uncured silicone core layer has a wet film thickness of 1 mil to 10 mils.

In some embodiments, the method of manufacturing 300 comprises curing 314 the second uncured silicone core layer so as to form a second cured silicone core layer. In some embodiments, curing 314 proceeds under conditions sufficient to at least partially cure the second uncured silicone core layer. In some embodiments, curing 314 proceeds under conditions sufficient to fully or at least substantially cure the second uncured silicone core layer. In some embodiments, curing 314 comprises heating for a duration sufficient to at least partially cure the second uncured silicone core layer. In some embodiments, curing 314 comprises heating for a duration sufficient to fully or at least substantially cure the second uncured silicone core layer. In some embodiments, curing 314 may comprise exposing to at least one of moisture, ultraviolet light, or other stimulus sufficient to induce curing.

In some embodiments, curing 314 comprises heating to a temperature of 80° C. to 400° C. In some embodiments, curing 314 comprises heating to a temperature of 80° C. to 380° C. In some embodiments, curing 314 comprises heating to a temperature of 80° C. to 360° C. In some embodiments, curing 314 comprises heating to a temperature of 80° C. to 340° C. In some embodiments, curing 314 comprises heating to a temperature of 80° C. to 320° C. In some embodiments, curing 314 comprises heating to a temperature of 80° C. to 300° C. In some embodiments, curing 314 comprises heating to a temperature of 80° C. to 280° C. In some embodiments, curing 314 comprises heating to a temperature of 80° C. to 260° C. In some embodiments, curing 314 comprises heating to a temperature of 80° C. to 240° C. In some embodiments, curing 314 comprises heating to a temperature of 80° C. to 220° C. In some embodiments, curing 314 comprises heating to a temperature of 80° C. to 200° C. In some embodiments, curing 314 comprises heating to a temperature of 80° C. to 180° C. In some embodiments, curing 314 comprises heating to a temperature of 80° C. to 160° C. In some embodiments, curing 314 comprises heating to a temperature of 80° C. to 140° C. In some embodiments, curing 314 comprises heating to a temperature of 80° C. to 120° C. In some embodiments, curing 314 comprises heating to a temperature of 80° C. to 100° C.

In some embodiments, curing 314 comprises heating to a temperature of 100° C. to 400° C. In some embodiments, curing 314 comprises heating to a temperature of 120° C. to 400° C. In some embodiments, curing 314 comprises heating to a temperature of 140° C. to 400° C. In some embodiments, curing 314 comprises heating to a temperature of 160° C. to 400° C. In some embodiments, curing 314 comprises heating to a temperature of 180° C. to 400° C. In some embodiments, curing 314 comprises heating to a temperature of 200° C. to 400° C. In some embodiments, curing 314 comprises heating to a temperature of 220° C. to 400° C. In some embodiments, curing 314 comprises heating to a temperature of 240° C. to 400° C. In some embodiments, curing 314 comprises heating to a temperature of 260° C. to 400° C. In some embodiments, curing 314 comprises heating to a temperature of 280° C. to 400° C. In some embodiments, curing 314 comprises heating to a temperature of 300° C. to 400° C. In some embodiments, curing 314 comprises heating to a temperature of 320° C. to 400° C. In some embodiments, curing 314 comprises heating to a temperature of 340° C. to 400° C. In some embodiments, curing 314 comprises heating to a temperature of 360° C. to 400° C. In some embodiments, curing 314 comprises heating to a temperature of 380° C. to 400° C.

It will be appreciated that steps 312 and 314 may be repeated one or more times until a desired thickness of the multi-layered silicone composite and/or the cured silicone core layer(s) is obtained.

In some embodiments, the method of manufacturing 300 comprises applying 316 the silicone top layer composition to a surface of the second cured silicone core layer, so as to form an uncured silicone top layer. In some embodiments, applying 316 comprises composite the silicone top layer composition onto the surface of the second cured silicone core layer. In some embodiments, applying 316 comprises laminating the silicone top layer composition onto the surface of the second cured silicone core layer. In some embodiments, applying 316 comprises extruding the silicone top layer composition onto the surface of the second cured silicone core layer. In some embodiments, applying 316 comprises bonding the silicone top layer composition to the second surface of the reinforcement layer. In some embodiments, applying 316 comprises pouring the silicone top layer composition onto the surface of the second cured silicone core layer. In some embodiments, applying 316 comprises disposing the silicone top layer composition onto the surface of the second cured silicone core layer. In some embodiments, applying 316 comprises contacting the silicone top layer composition with the surface of the second cured silicone core layer. In some embodiments, the silicone top layer composition does not comprise at least one of a blowing agent, a foaming agent, or any combination thereof. In some embodiments, the silicone top layer composition is different from the silicone core layer composition. In some embodiments, the silicone top layer composition is formulated such that the silicone top layer composition does not result in a formation of a gas (e.g., gas bubbles) during curing of the silicone top layer composition. In some embodiments, the silicone top layer composition, when cured, has a smooth surface, a non-porous surface, a non-porous body, or any combination thereof.

In some embodiments, the uncured silicone top layer has a wet film thickness of 1 mil to 499 mils. In some embodiments, the uncured silicone top layer has a wet film thickness of 10 mils to 499 mils. In some embodiments, the uncured silicone top layer has a wet film thickness of 20 mils to 499 mils. In some embodiments, the uncured silicone top layer has a wet film thickness of 40 mils to 499 mils. In some embodiments, the uncured silicone top layer has a wet film thickness of 60 mils to 499 mils. In some embodiments, the uncured silicone top layer has a wet film thickness of 80 mils to 499 mils. In some embodiments, the uncured silicone top layer has a wet film thickness of 100 mils to 499 mils. In some embodiments, the uncured silicone top layer has a wet film thickness of 110 mils to 499 mils. In some embodiments, the uncured silicone top layer has a wet film thickness of 120 mils to 499 mils. In some embodiments, the uncured silicone top layer has a wet film thickness of 140 mils to 499 mils. In some embodiments, the uncured silicone top layer has a wet film thickness of 160 mils to 499 mils. In some embodiments, the uncured silicone top layer has a wet film thickness of 180 mils to 499 mils. In some embodiments, the uncured silicone top layer has a wet film thickness of 200 mils to 499 mils.

In some embodiments, the uncured silicone top layer has a wet film thickness of 220 mils to 499 mils. In some embodiments, the uncured silicone top layer has a wet film thickness of 240 mils to 499 mils. In some embodiments, the uncured silicone top layer has a wet film thickness of 260 mils to 499 mils. In some embodiments, the uncured silicone top layer has a wet film thickness of 280 mils to 499 mils. In some embodiments, the uncured silicone top layer has a wet film thickness of 300 mils to 499 mils. In some embodiments, the uncured silicone top layer has a wet film thickness of 320 mils to 499 mils. In some embodiments, the uncured silicone top layer has a wet film thickness of 340 mils to 499 mils. In some embodiments, the uncured silicone top layer has a wet film thickness of 360 mils to 499 mils. In some embodiments, the uncured silicone top layer has a wet film thickness of 380 mils to 499 mils. In some embodiments, the uncured silicone top layer has a wet film thickness of 400 mils to 499 mils. In some embodiments, the uncured silicone top layer has a wet film thickness of 420 mils to 499 mils. In some embodiments, the uncured silicone top layer has a wet film thickness of 440 mils to 499 mils. In some embodiments, the uncured silicone top layer has a wet film thickness of 460 mils to 499 mils. In some embodiments, the uncured silicone top layer has a wet film thickness of 480 mils to 499 mils.

In some embodiments, the uncured silicone top layer has a wet film thickness of 1 mil to 480 mils. In some embodiments, the uncured silicone top layer has a wet film thickness of 1 mil to 460 mils. In some embodiments, the uncured silicone top layer has a wet film thickness of 1 mil to 440 mils. In some embodiments, the uncured silicone top layer has a wet film thickness of 1 mil to 420 mils. In some embodiments, the uncured silicone top layer has a wet film thickness of 1 mil to 400 mils. In some embodiments, the uncured silicone top layer has a wet film thickness of 1 mil to 380 mils. In some embodiments, the uncured silicone top layer has a wet film thickness of 1 mil to 360 mils. In some embodiments, the uncured silicone top layer has a wet film thickness of 1 mil to 340 mils. In some embodiments, the uncured silicone top layer has a wet film thickness of 1 mil to 320 mils. In some embodiments, the uncured silicone top layer has a wet film thickness of 1 mil to 300 mils.

In some embodiments, the uncured silicone top layer has a wet film thickness of 1 mil to 280 mils. In some embodiments, the uncured silicone top layer has a wet film thickness of 1 mil to 260 mils. In some embodiments, the uncured silicone top layer has a wet film thickness of 1 mil to 240 mils. In some embodiments, the uncured silicone top layer has a wet film thickness of 1 mil to 220 mils. In some embodiments, the uncured silicone top layer has a wet film thickness of 1 mil to 200 mils. In some embodiments, the uncured silicone top layer has a wet film thickness of 1 mil to 180 mils. In some embodiments, the uncured silicone top layer has a wet film thickness of 1 mil to 160 mils. In some embodiments, the uncured silicone top layer has a wet film thickness of 1 mil to 140 mils. In some embodiments, the uncured silicone top layer has a wet film thickness of 1 mil to 120 mils. In some embodiments, the uncured silicone top layer has a wet film thickness of 1 mil to 100 mils. In some embodiments, the uncured silicone top layer has a wet film thickness of 1 mil to 80 mils. In some embodiments, the uncured silicone top layer has a wet film thickness of 1 mil to 60 mils. In some embodiments, the uncured silicone top layer has a wet film thickness of 1 mil to 40 mils. In some embodiments, the uncured silicone top layer has a wet film thickness of 1 mil to 20 mils. In some embodiments, the uncured silicone top layer has a wet film thickness of 1 mil to 10 mils.

In some embodiments, the method of manufacturing 300 comprises curing 318 the uncured silicone top layer, so as to form a cured silicone top layer. In some embodiments, curing 318 proceeds under conditions sufficient to at least partially cure the uncured silicone top layer. In some embodiments, curing 318 proceeds under conditions sufficient to fully or at least substantially cure the uncured silicone top layer. In some embodiments, curing 318 comprises heating for a duration sufficient to at least partially cure the uncured silicone top layer. In some embodiments, curing 318 comprises heating for a duration sufficient to fully or at least substantially cure the uncured silicone top layer. In some embodiments, curing 318 may comprise exposing to at least one of moisture, ultraviolet light, or other stimulus sufficient to induce curing. In some embodiments, the step of curing 318 the uncured silicone top layer does not result in a foam structure in the cured silicone top layer. For example, in some embodiments, the step of curing 318 does not result in formation of a gas (e.g., gas bubbles). In some embodiments, the step of curing 318 does not result in formation of a foam structure in the cured silicone top layer.

In some embodiments, curing 318 comprises heating to a temperature of 80° C. to 400° C. In some embodiments, curing 318 comprises heating to a temperature of 80° C. to 380° C. In some embodiments, curing 318 comprises heating to a temperature of 80° C. to 360° C. In some embodiments, curing 318 comprises heating to a temperature of 80° C. to 340° C. In some embodiments, curing 318 comprises heating to a temperature of 80° C. to 320° C. In some embodiments, curing 318 comprises heating to a temperature of 80° C. to 300° C. In some embodiments, curing 318 comprises heating to a temperature of 80° C. to 280° C. In some embodiments, curing 318 comprises heating to a temperature of 80° C. to 260° C. In some embodiments, curing 318 comprises heating to a temperature of 80° C. to 240° C. In some embodiments, curing 318 comprises heating to a temperature of 80° C. to 220° C. In some embodiments, curing 318 comprises heating to a temperature of 80° C. to 200° C. In some embodiments, curing 318 comprises heating to a temperature of 80° C. to 180° C. In some embodiments, curing 318 comprises heating to a temperature of 80° C. to 160° C. In some embodiments, curing 318 comprises heating to a temperature of 80° C. to 140° C. In some embodiments, curing 318 comprises heating to a temperature of 80° C. to 120° C. In some embodiments, curing 318 comprises heating to a temperature of 80° C. to 100° C.

In some embodiments, curing 318 comprises heating to a temperature of 100° C. to 400° C. In some embodiments, curing 318 comprises heating to a temperature of 120° C. to 400° C. In some embodiments, curing 318 comprises heating to a temperature of 140° C. to 400° C. In some embodiments, curing 318 comprises heating to a temperature of 160° C. to 400° C. In some embodiments, curing 318 comprises heating to a temperature of 180° C. to 400° C. In some embodiments, curing 318 comprises heating to a temperature of 200° C. to 400° C. In some embodiments, curing 318 comprises heating to a temperature of 220° C. to 400° C. In some embodiments, curing 318 comprises heating to a temperature of 240° C. to 400° C. In some embodiments, curing 318 comprises heating to a temperature of 260° C. to 400° C. In some embodiments, curing 318 comprises heating to a temperature of 280° C. to 400° C. In some embodiments, curing 318 comprises heating to a temperature of 300° C. to 400° C. In some embodiments, curing 318 comprises heating to a temperature of 320° C. to 400° C. In some embodiments, curing 318 comprises heating to a temperature of 340° C. to 400° C. In some embodiments, curing 318 comprises heating to a temperature of 360° C. to 400° C. In some embodiments, curing 318 comprises heating to a temperature of 380° C. to 400° C.

In some embodiments, the method of manufacturing 300 comprises removing 320 the temporary support from the first cured silicone core layer. In some embodiments, removing 320 comprises peeling the temporary support from the first cured silicone core layer. In some embodiments, removing 320 comprises pulling the temporary support from the first cured silicone layer. In some embodiments, removing 320 comprises peeling, pulling, withdrawing, detaching, decoupling, or otherwise dissociating the temporary support from the first cured silicone core layer.

In some embodiments, the method of manufacturing 300 comprises applying 322 the adhesive composition to the first cured silicone core layer, so as to form an adhesive layer. In some embodiments, applying 322 comprises coating the adhesive composition onto the first cured silicone core layer. In some embodiments, applying 322 comprises laminating the adhesive composition onto the first cured silicone core layer. In some embodiments, applying 322 comprises extruding the adhesive composition onto the first cured silicone core layer. In some embodiments, applying 322 comprises bonding the adhesive composition to the first cured silicone core layer. In some embodiments, applying 322 comprises pouring the adhesive composition onto the first cured silicone core layer. In some embodiments, applying 322 comprises disposing the adhesive composition onto the first cured silicone core layer. In some embodiments, applying 322 comprises contacting the adhesive composition with the first cured silicone core layer.

Any one or more of the embodiments disclosed herein shall be understood to be combinable without departing from the scope or spirit of the disclosure.

What is claimed is:

1. A roofing membrane comprising:
a multi-layered silicone composite;
wherein the multi-layered silicone composite comprises:
a cured silicone top layer;
wherein the cured silicone top layer does not have a foam structure; and
at least one cured silicone core layer;
wherein the at least one cured silicone core layer is located on the cured silicone top layer;
wherein the at least one cured silicone core layer has a foam structure;
wherein the cured silicone top layer has a thickness that is at least 50% less than a total thickness of the multi-layered silicone composite; and
an adhesive layer,
wherein the at least one cured silicone core layer is located between the adhesive layer and the cured silicone top layer.

2. The roofing membrane of claim 1, wherein the cured silicone top layer does not comprise a blowing agent; wherein the at least one cured silicone core layer comprises a blowing agent.

3. The roofing membrane of claim 1, wherein the foam structure of the at least one cured silicone core layer comprises a closed cell foam.

4. The roofing membrane of claim 1, wherein the foam structure of the at least one cured silicone core layer comprises an open cell foam.

5. The roofing membrane of claim 1, wherein a density of the at least one cured silicone core layer is less than a density of the cured silicone top layer.

6. The roofing membrane of claim 1, wherein a density of the at least one cured silicone core layer is 0.4 g/cm³ to 2 g/cm³.

7. The roofing membrane of claim 1, wherein the multi-layered silicone composite has a thickness of 2 mils to 500 mils.

8. The roofing membrane of claim 1, wherein the adhesive layer has a thickness of 1 mil to 200 mils.

9. The roofing membrane of claim 1, wherein the at least one cured silicone core layer comprises a sufficient amount of cured silicone core layers such that the multi-layered silicone composite has a thickness of 2 mils to 500 mils.

10. The roofing membrane of claim 1, further comprising:
a release liner,
wherein the release liner covers the adhesive layer.

11. The roofing membrane of claim 1, further comprising:
a first release liner,
wherein the first release liner covers the cured silicone top layer; and
a second release liner,
wherein the second release liner covers the adhesive layer.

12. A roofing system comprising:
a roofing substrate; and
a roofing membrane,
wherein the roofing membrane is located on the roofing substrate;
wherein the roofing membrane comprises:
a multi-layered silicone composite;
wherein the multi-layered silicone composite comprises:
a cured silicone top layer;
wherein the cured silicone top layer does not have a foam structure; and
at least one cured silicone core layer;
wherein the at least one cured silicone core layer is located on the cured silicone top layer;
wherein the at least one cured silicone core layer has a foam structure;
wherein the cured silicone top layer has a thickness that is at least 50% less than a total thickness of the multi-layered silicone composite; and
an adhesive layer,
wherein the adhesive layer is located between the at least one cured silicone core layer and the roofing substrate;
wherein the adhesive layer adheres the roofing membrane to the roofing substrate.

13. The roofing system of claim 12, wherein the roofing substrate comprises at least one of a plywood substrate, a glass substrate, a cellulosic substrate, a roof shingle, a mat, a fabric, a glass mat, a fiberglass mat, an underlayment, a roofing membrane, a roof deck, a photovoltaic (PV) panel, a modified bitumen (MODBIT) material, a roll good, a polyisocyanurate (ISO) foam board, a cover board, a pipe, a base sheet, a chimney, a wax paper, or any combination thereof.

14. The roofing system of claim 12, wherein the roofing membrane contacts the roofing substrate.

15. The roofing system of claim 12, wherein a density of the at least one cured silicone core layer is less than a density of the cured silicone top layer.

16. The roofing system of claim 12, wherein a density of the at least one cured silicone core layer is 0.4 g/cm³ to 2 g/cm³.

17. The roofing system of claim 12, wherein the multi-layered silicone composite has a thickness of 2 mils to 500 mils.

18. The roofing system of claim 12, wherein the adhesive layer has a thickness of 1 mil to 200 mils.

19. A method of installation comprising:
obtaining a roofing membrane,
wherein the roofing membrane comprises:
a multi-layered silicone composite;
wherein the multi-layered silicone composite comprises:
a cured silicone top layer;
wherein the cured silicone top layer does not have a foam structure; and
at least one cured silicone core layer;
wherein the at least one cured silicone core layer is located on the cured silicone top layer;
wherein the at least one cured silicone core layer has a foam structure;
wherein the cured silicone top layer has a thickness that is at least 50% less than a total thickness of the multi-layered silicone composite;
an adhesive layer,
wherein the at least one cured silicone core layer is located between the adhesive layer and the cured silicone top layer; and
a release liner,
wherein the release liner covers the adhesive layer;
removing the release liner from the roofing membrane, so as to expose the adhesive layer; and
contacting the adhesive layer of the roofing membrane to a roofing substrate, so as to adhere the roofing membrane to the roofing substrate.

20. The method of claim 19, wherein the roofing substrate comprises at least one of a plywood substrate, a glass substrate, a cellulosic substrate, a roof shingle, a mat, a fabric, a glass mat, a fiberglass mat, an underlayment, a roofing membrane, a roof deck, a photovoltaic (PV) panel, a modified bitumen (MODBIT) material, a roll good, a polyisocyanurate (ISO) foam board, a cover board, a pipe, a base sheet, a chimney, a wax paper, or any combination thereof.
